(19) United States
(12) Patent Application Publication
(10) Pub. No.: US 2016/0289801 A1
(43) Pub. Date: Oct. 6, 2016

(54) HIGH-PURITY ALUMINIUM GRAIN MATERIAL AND METHOD FOR PRODUCING THE SAME

(71) Applicant: SUMITOMO CHEMICAL COMPANY, LIMITED, Tokyo (JP)

(72) Inventors: Hiroaki HOSHIKAWA, Niihama-shi (JP); Yuki KUBO, Niihama-shi (JP); Akira NAGATA, Niihama-shi (JP)

(73) Assignee: SUMITOMO CHEMICAL COMPANY, LIMITED, Tokyo (JP)

(21) Appl. No.: 15/089,640

(22) Filed: Apr. 4, 2016

(30) Foreign Application Priority Data
Apr. 6, 2015 (JP) 2015-077854

(51) Int. Cl. C22C 21/00; B21F 11/00; B08B 3/08; C23G 1/22; B65D 81/20; C23G 1/12

(52) U.S. Cl. CPC C22C 21/00; B65D 81/2023; C23G 1/125; B08B 3/08; C23G 1/22; B21F 11/00

(57) ABSTRACT

An object of the present invention is to provide an aluminium grain material having significantly high purity, and a method for producing the same. Disclosed is an aluminium grain material having an average mass per grain of 0.01 to 10 g, wherein the total content of twelve elements of silicon (Si), iron (Fe), copper (Cu), magnesium (Mg), titanium (Ti), vanadium (V), chromium (Cr), manganese (Mn), nickel (Ni), zinc (Zn), gallium (Ga), and zirconium (Zr) in the aluminium grain material, measured by glow discharge mass spectrometry, is 5 ppm by mass or less.

### CROSS-REFERENCE TO RELATED PATENT APPLICATION

The present application claims priority to Japan Patent Application No. 2015-077854 filed Apr. 6, 2015, which is incorporated herein by reference in its entirety.

### BACKGROUND

1. Technical Field

The present disclosure relates to a high-purity aluminium grain material, and more particularly to a high-purity aluminium grain material which is preferred as a material for forming a film of aluminium or an aluminium compound, and a method for producing the same.

2. Description of the Related Art

Aluminium is a metal element which is used in a wide range of fields and is used, for example, as a wiring material of semiconductors. In fields of electronic industry and semiconductors, aluminium is used as a material for forming a film, and a thin film is formed by vapor phase growth process such as resistance heating vapor deposition and electron beam vapor deposition processes (THE JOURNAL OF VACUUM SCIENCE AND TECHNOLOGY, Vol. 9 (1972), pp. 33). In general, there is a need for the material for forming a film in fields of electronic industry and semiconductors to have high purity. If the material does not have high purity, it may become difficult to control physical properties such as electrical conduction property of the resulting thin film. In the case of performing vacuum vapor deposition, impurities adsorbed or mixed in the material for forming a film may be quickly released involved in melting to cause scattering of the material for forming a film, thus leading to damage of a substrate for vapor deposition. There has been known, as such high-purity aluminium, for example, aluminium which is produced by a segregation process or a three-layer electrolytic refining process, and usually has a purity of about 99.99 to 99.999% by mass.

In the material for forming a film, not only a purity, but also a shape is an important factor. In fields of electronic industry and semiconductors, the material for forming a film is aligned and fed by a parts feeder so as to automate feed of the material for forming a film to a vessel in a film-forming apparatus. In order to align and feed by the parts feeder, there is a need that the material for forming a film is a comparatively small grain material (for example, a grain shape having a diameter of about several millimeters). If the material for forming a film has a comparatively small grain material, since a surface area per unit mass increases, adhesion of impurities and a reaction such as surface oxidation are likely to occur, thus purity tends to decrease. Depending on a metal element, a method for producing a comparatively small grain material having high purity includes, for example, a method in which a high-purity metal shot is obtained by adding dropwise a molten metal in a cooling solvent (JP 2012-125900 A).

However, known grain materials are likely to undergo contamination in the production process, and also have low purity. The metal shot may also undergo contamination with components from peripheral members in the production process, and is not satisfactory in purity.

### SUMMARY

In light of these circumstances, the present invention has been made and an object thereof is to provide an aluminium grain material having significantly high purity, and a method for producing the same.

The present inventors have made an intensive study on a high-purity aluminium grain material and a method for producing the same so as to achieve the above object, thus leading to the present invention.

The present invention includes the following preferred embodiments.
[1] An aluminium grain material having an average mass per grain of 0.01 to 10 g, wherein

the total content of twelve elements of silicon (Si), iron (Fe), copper (Cu), magnesium (Mg), titanium (Ti), vanadium (V), chromium (Cr), manganese (Mn), nickel (Ni), zinc (Zn), gallium (Ga), and zirconium (Zr) in the aluminium grain material, measured by glow discharge mass spectrometry, is 5 ppm by mass or less.
[2] The aluminium grain material according to [1], wherein the total content of the twelve elements is 2.5 ppm by mass or less.
[3] The aluminium grain material according to [1] or [2], wherein variation in mass indicated by a value obtained by dividing a standard deviation of the mass of the aluminium grain material by an average of the mass, is 5% or less, in the twenty aluminium grain materials.
[4] The aluminium grain material according to any one of [1] to [3], wherein the aluminium grain material is a cut wire.
[5] The aluminium grain material according to [4], wherein the cut wire has a wire diameter of 0.3 to 20 mm and a length of 1 to 50 mm.
[6] The aluminium grain material according to [4] or [5], wherein variation in wire diameter indicated by a value obtained by dividing a standard deviation of the wire diameter of the cut wire by an average of the wire diameter, is 5% or less, and variation in length indicated by a value obtained by dividing a standard deviation of the length of the cut wire by an average of the length, is 5% or less, in the twenty cut wires.
[7] The aluminium grain material according to any one of [1] to [6] for forming a film of aluminium, or a film of aluminium-containing inorganic compound(s).
[8] The aluminium grain material according to any one of [1] to [7] vacuum-packaged in a resin bag not containing a lubricant, an antioxidant, and an antiblocking agent.
[9] A method for producing the aluminium grain material according to any one of [1] to [8], which comprises:

a cutting step of cutting an aluminium wire material to obtain a cut wire, and

a cleaning step of bringing the cut wire into contact with a cleaning liquid to obtain the aluminium grain material.
[10] The method according to [9], wherein the cleaning liquid is a solution containing at least one selected from the group consisting of hydrochloric acid, nitric acid, sulfuric acid, oxalic acid, citric acid, sodium carbonate, tartaric acid, sodium hydroxide, phosphate, sodium gluconate, and sodium metasilicate.
[11] The method according to [9] or [10], wherein a mass reduction rate of the cut wire after contacting with the cleaning liquid is in a range of 0.01 to 20% based on the mass of the cut wire before contacting with the cleaning liquid in the cleaning step.
[12] The method according to [9] or [10], wherein a mass reduction rate of the cut wire after contacting with the cleaning liquid is in a range of 0.1 to 10% based on the mass of the cut wire before contacting with the cleaning liquid in the cleaning step.

Because of significantly high purity, the aluminium grain material of an embodiment of the present invention is capable of obtaining a thin film having excellent physical properties such as electrical conduction property when using as a material for forming a film of aluminium, or a material for forming a film of aluminium-containing inorganic compound(s).

### DETAILED DESCRIPTION OF THE EMBODIMENT

The aluminium grain material of the present invention has an average mass per grain of 0.01 to 10 g, and the total content of twelve elements of silicon (Si), iron (Fe), copper (Cu), magnesium (Mg), titanium (Ti), vanadium (V), chromium (Cr), manganese (Mn), nickel (Ni), zinc (Zn), gallium (Ga), and zirconium (Zr) in the aluminium grain material, measured by glow discharge mass spectrometry, is 5 ppm by mass or less.

The total content of twelve elements of Si, Fe, Cu, Mg, Ti, V, Cr, Mn, Ni, Zn, Ga, and Zr in the aluminium grain material, measured by glow discharge mass spectrometry, is 5 ppm by mass or less, preferably 2.5 ppm by mass or less, more preferably 2 ppm by mass or less, still more preferably 1 ppm by mass or less, and very preferably 0.9 ppm by mass or less. It is desirable that the total content of the above-mentioned twelve elements in the aluminium grain material of the present invention is the upper limit value or less since the aluminium grain material contains very few impurities and is therefore suitable as a material for forming a film capable of producing a high-purity thin film. There is no particular limitation on the lower limit value of the total content of the above-mentioned twelve elements in the aluminium grain material, and the lower limit value is usually 0.1 ppm by mass or more.

In the present invention, when the total content of the above-mentioned twelve elements in the aluminium grain material is measured by glow discharge mass spectrometry, the measurement is preferably performed by recasting the aluminium grain material. Recasting of the aluminium grain material enables the measurement of the total content of the above-mentioned twelve elements in the entire aluminium grain material.

The aluminium grain material of the present invention has a granular shape, for example, such as a spherical shape, an ellipsoidal shape, a columnar shape, a cylindrical shape, a fiber shape, a flake shape, a pellet shape, or a tablet shape. The aluminium grain material of the present invention can be in the form of a shot or a cut wire according to the production method thereof. Of these from the viewpoint an aluminium grain material with less variation in shape is likely to be obtained and automatic feeding to a vessel in a film-forming apparatus can be easily performed in the case of performing vapor deposition using as a material for forming a film, the aluminium grain material of the present invention is preferably a cut wire. The cut wire has a columnar shape formed by cutting a wire material (wire), and the cut wire may undergo distortion in its cross-section in the case of cutting the wire material. The shot has an approximately spherical shape formed by adding dropwise a molten metal in a cooling solvent.

The aluminium grain material of the present invention has an average mass per grain in a range of 0.01 to 10 g, preferably 0.05 to 5 g, and more preferably 0.1 to 2 g. It is desirable that the average mass per grain of the aluminium grain material of the present invention is in the above range since workability including automatic feeding to a vessel in a film-forming apparatus is improved when using the aluminium grain material of the present invention as the material for forming a film. The average mass of the aluminium grain material of the present invention can be determined by measuring each mass of twenty aluminium grain materials, and calculating an average value of the measured values.

In the present invention, variation in mass indicated by a value, which is obtained by dividing a standard deviation of the mass of the aluminium grain material by an average of the mass, in twenty aluminium grain materials is preferably 5% or less, more preferably 2% or less, and still more preferably 1% or less. It is desirable that variation in mass of the aluminium grain material is in the above range since variation in mass of each aluminium grain materials is less likely to occur, and also automatic feeding to a vessel in a film-forming apparatus can be easily performed in the case of performing vapor deposition using as a material for forming a film due to comparatively small aluminium grain material. It is also desirable that the aluminium grain material is preferred as the material for forming a film since it becomes is easy to control the amount of the film formed. The lower limit value of the variation in mass is usually 0% or more.

When the aluminium grain material of the present invention is a cut wire, there is no particular limitation on shape of the cross-section of the cut wire, and the aluminium grain material usually has a circular shape or an elliptical shape. In this case, the cut wire preferably has a wire diameter in a range of 0.3 to 20 mm, more preferably 1 to 15 mm, and still more preferably 2 to 10 mm, and the cut wire preferably has a length in a range of 1 to 50 mm, more preferably 2 to 30 mm, and still more preferably 3 to 20 mm. It is desirable that the wire diameter and length of the cut wire are in the above range since variation in shape of each aluminium grain materials is less likely to occur, and also automatic feeding to a vessel in a film-forming apparatus can be easily performed in the case of performing vapor deposition using as a material for forming a film due to comparatively small aluminium grain material. It is also desirable that the aluminium grain material is preferred as the material for forming a film since it becomes easy to control the amount of the film formed. The wire diameter of the cut wire means a diameter of a circular cross-section of the cut wire, and the length of the cut wire means a length of the cut wire in a direction perpendicular to a circular shaped cross-section. When the cut wire has an elliptical cross-section, the wire diameter of the cut wire means an average value of the major axis and the minor axis.

Variation in wire diameter indicated by a value, which is obtained by dividing a standard deviation of the wire diameter of the cut wire by an average of the wire diameter, is preferably 5% or less, more preferably 2% or less, and still more preferably 1% or less. Variation in length indicated by a value, which is obtained by dividing a standard deviation of the length of the cut wire by an average of the length, is preferably 5% or less, more preferably 2% or less, and still more preferably 1% or less. It is desirable that variation in wire diameter and variation in length of the cut wire are in the above range since variation in shape of the aluminium grain material is less likely to occur, and also the aluminium grain material is preferred as a material for forming a film. The lower limit value of variation in wire diameter and variation in length is usually 0% or more.

The wire diameter and length of the cut wire can be obtained by measuring each of wire diameters and lengths of twenty cut wires using a digital caliper or a digital thickness gauge, and calculating an average of the measured values, while the standard deviations can be obtained by calculating based on the measured values of wire diameters and lengths of twenty cut wires.

The present invention also provides an aluminium grain material of the present invention, which is vacuum-packaged in a resin bag not containing a lubricant, an antioxidant, and an antiblocking agent. Vacuum packaging in the resin bag enables suppression of adhesion of impurities from the periphery, and degradation of a surface of the aluminium grain material due to a reaction with moisture. The resin bag is usually mixed with a lubricant so as to reduce friction. However, since the resin bag in the present invention does not contain a lubricant, an antioxidant, and an antiblocking agent, the aluminium grain material thus packaged is not contaminated with these additives, thus making it possible to maintain high purity.

Examples of the resin constituting the resin bag include polyolefin resins such as a polyethylene resin and a polypropylene resin; polyvinyl resins such as a polyvinyl acetate resin, a polystyrene resin, and a polyvinyl chloride resin; polyester resins such as a polyethylene terephthalate resin and a polyethylene naphthalate resin; polyether resins such as a polyethylene oxide resin; and polyamide resins such as a nylon 6 resin and a nylon 66 resin. The resin bag may be composed of these resins which are used alone, or may be composed of these resins which are used in combination in a multi-layered form. The resin bag includes, for example, COPACK (registered trademark) manufactured by ASAHIKASEI PAX CORPORATION.

The aluminium grain material of the present invention can be produced by a method comprising:

a cutting step of cutting an aluminium wire material to obtain a cut wire, and

a cleaning step of bringing a cut wire into contact with a cleaning liquid to obtain the aluminium grain material.

A cut wire is obtained by cutting the aluminium wire material in the cutting step. The wire diameter of the aluminium wire material is preferably in a range of 0.3 to 20 mm, more preferably 1 to 15 mm, and still more preferably 2 to 10 mm, from the viewpoint of enabling automatic feeding to a vessel in a film-forming apparatus and an improvement in handleability.

From the viewpoint of increasing a purity of the resulting aluminium grain material, the purity of the aluminium wire material is preferably 99.9995% by mass or more, more preferably 99.99975% by mass or more, and still more preferably 99.9999% by mass or more. There is no particular limitation on the upper limit value of the purity of the aluminium wire material, and the upper limit value is usually 99.99999% by mass or less.

From the viewpoint of increasing the purity of the resulting aluminium grain material, the total content of twelve elements of Si, Fe, Cu, Mg, Ti, V, Cr, Mn, Ni, Zn, Ga, and Zr in the aluminium wire material is 5 ppm by mass or less, preferably 2.5 ppm by mass or less, more preferably 2 ppm by mass or less, still more preferably 1 ppm by mass or less, and very preferably 0.9 ppm by mass or less. There is no particular limitation on the lower limit value of the total content of the above-mentioned twelve elements in the aluminium wire material, and the lower limit value is usually 0.1 ppm by mass or more.

Such a high-purity aluminium can be obtained, for example, by purifying aluminium having a purity of about 99.9% by mass. Examples of the purification process include known purification processes such as a directional solidification process, a segregation process, a three-layer electrolytic refining process, a zone melting refining process, and an ultra-high vacuum melting refining process, and a combination thereof. Specifically, it is possible to use a purification process disclosed in JP 5274981 B 1.

From the viewpoint of enabling automatic feeding to a vessel in a film-forming apparatus and an improvement in handleability, the cutting length in the case of cutting the aluminium wire material is preferably in a range of 1 to 50 mm, more preferably 2 to 30 mm, and still more preferably 3 to 20 mm. There is no particular limitation on the cutting device for cutting the aluminium wire material, and examples thereof include an automatic cutting machine, an automatic linear cutting machine, and an automatic heading machine. Of these, an automatic linear cutting machine is preferable. Use of an automatically cutting machine enables automatic feeding of the aluminium wire material having a predetermined length. The automatic cutting machine includes a shear blade type digital cutter manufactured by I.TEC Corporation, the automatic linear cutting machine includes an automatic linear cutting machine for short material manufactured by Takashima High Speed Wire Straightening Machine Works Co., Ltd., and the automatic heading machine includes a cold heading machine manufactured by ASAHI SUNAC CORPORATION. A cutting blade to be used in this case includes those made of superalloy, stainless steel, and the like.

After the cutting step, cleaning may be performed using an organic solvent so as to remove oil adhered to the cut wire. Examples of the organic solvent include alcohol solvents such as ethanol; hydrocarbon solvents such as hexane; and kerosene. In order to remove unnecessary projection (burr) which can be formed during cutting after the cutting step, machine polishing such as grinding or barrel processing may be performed.

In the cleaning step, the cut wire obtained in the cutting step is brought into contact with a cleaning liquid. It is possible to use, as the method of bringing the cut wire into contact with the cleaning liquid, a method of immersing the cut wire in the cleaning liquid. In the case of immersing the cut wire in the cleaning liquid, stirring may be performed using a ball mill or a shaker, or an ultrasonic treatment may be performed, so as to efficiently bring the cut wire into contact with the cleaning liquid.

There is no particular limitation on the cleaning liquid as long as it enables elution of a surface of the cut wire, and examples thereof include a solution containing an acid, an alkali, or a salt. Examples of the acid include mineral acids such as hydrochloric acid, nitric acid, sulfuric acid, phosphoric acid, and boric acid; and organic acids such as formic acid, acetic acid, propionic acid, oxalic acid, citric acid, and tartaric acid. Examples of the alkali include sodium hydroxide, potassium hydroxide, calcium hydroxide, sodium carbonate, and ammonia and the like. Examples of the salt include chelating agents such as phosphate and sodium gluconate; and saponifiable cleaning liquids such as sodium metasilicate. Of these, the cleaning liquid is preferably a solution containing at least one selected from the group consisting of hydrochloric acid, nitric acid, sulfuric acid, oxalic acid, citric acid, sodium carbonate, tartaric acid, sodium hydroxide, phosphate, sodium gluconate, and sodium metasilicate since a high-purity cleaning liquid is easily obtained at low cost and it is industrially advantageous. From the viewpoint of obtaining an aluminium grain material having higher purity, the cleaning liquid is more preferably a solution containing at least one selected from the group consisting of hydrochloric acid, nitric acid, sulfuric acid, oxalic acid, citric acid, sodium carbonate, tartaric acid, and sodium hydroxide, and still more preferably a solution containing hydrochloric acid, nitric acid, sulfuric acid, oxalic acid, citric acid, sodium carbonate, tartaric acid, or sodium hydroxide. These cleaning liquids may contain a surfactant.

It is preferable that the cleaning liquid does not contain elements serving as an impurity source, such as sulfur, iron, and silicon. It is desirable that the cleaning liquid does not contain elements such as sulfur, iron, and silicon since impurities are less likely to adhere to a surface of the aluminium grain material obtained after cleaning, and thus high purity is easily obtained.

The cleaning liquid in the present invention can be usually prepared by mixing an acid, an alkali, or a salt with an aqueous solution. Examples of the aqueous solution include water, and a mixture of water and a water-soluble organic solvent and the like. Examples of the water-soluble organic solvent include alcohols such as methanol, ethanol, propylene glycol, and ethylene glycol.

There is no particular limitation on the concentration of the acid, alkali, or salt in the cleaning liquid, and the concentration can be appropriately adjusted according to the type of the acid, alkali, or salt to be used. When the cleaning liquid is a strong acid or a strong alkali, the concentration of the acid or alkali in the cleaning liquid is preferably in a range of 0.1 to 35% by mass, more preferably 1 to 20% by mass, and still more preferably 2 to 10% by mass, based on the total amount of the cleaning liquid. When the cleaning liquid is a middle or weak acid, or a middle or weak alkali, the concentration of the acid or alkali in the cleaning liquid is preferably in a range of 5 to 85% by mass, more preferably 10 to 75% by mass, and still more preferably 40 to 65% by mass, based on the total amount of the cleaning liquid. It is desirable that the concentration of the acid or alkali in the cleaning liquid is in the above range since impurities on a surface of the aluminium grain material are efficiently removed to efficiently obtain a high-purity aluminium grain material suited as a material for forming a film. When the cleaning liquid contains a salt, the concentration of the slat in the cleaning liquid is preferably in a range of 1 to 20% by mass, more preferably 2 to 15% by mass, and still more preferably 5 to 10% by mass based on the total amount of the cleaning liquid. It is desirable that the concentration of the salt in the cleaning liquid is in the above range since impurities on a surface of the aluminium grain material are efficiently removed to efficiently obtain a high-purity aluminium grain material which is free from adhesion of impurities.

When the cleaning liquid contains an acid, the pH of the cleaning liquid is preferably in a range of −1 to 4, and more preferably 0 to 3. When the cleaning liquid contains an alkali, the pH of the cleaning liquid is preferably in a range of 9 to 14, and more preferably 11 to 14. It is desirable that the pH of the cleaning liquid is in the above range since aluminium does not become hardly soluble, thus enabling efficient elution of a surface of the cut wire. When the cleaning liquid contains a salt, the pH is not particularly limited, for example, near neutral (pH7).

It is also possible to use, as the cleaning liquid, an organic solvent. Examples of the organic solvent include alcohol solvents such as methanol, ethanol, and propylene glycol; ketone solvents such as acetone and methyl ethyl ketone; ether solvents such as diethyl ether, dioxane, and tetrahydrofuran; amide solvents such as N,N-dimethylformamide; sulfoxide solvents such as dimethyl sulfoxide; aliphatic hydrocarbon solvents such as n-hexane, methylene chloride, chloroform, and carbon tetrachloride; and aromatic hydrocarbon solvents such as benzene, toluene, xylene, and chlorobenzene. These organic solvents may be used alone, or two or more organic solvents may be used in combination.

There is no particular limitation on the temperature of the cleaning liquid in the case of immersing the cut wire, and the temperature is preferably in a range of 10° C. to 120° C., and more preferably 20 to 60° C. It is desirable that the temperature of the cleaning liquid in the case of immersing the cut wire is in the above range since satisfactory workability is achieved and also it becomes possible to carry out the cleaning step in a shorter time.

There is no particular limitation on the immersion method of the cut wire as long as it is possible to immerse the cut wire in the cleaning liquid. The immersion method may be either a method in which a cleaning liquid is continuously added, followed by retention for a predetermined time and further immersion while extraction, or a method in which a cut wire is immersed in a cleaning liquid, followed by retention for a predetermined time, followed by deliquoring, addition of a new cleaning liquid and further repetition of immersion and deliquoring. The immersion method may be either a method in which the cleaning liquid is entirely renewed, or a method in which the cleaning liquid is partially renewed.

The immersion time of the cut wire in cleaning liquid varies depending on the cleaning liquid and the concentration thereof and there is no particular limitation thereon. From the viewpoint of economy and cleaning efficiency, the immersion time is preferably in a range of 20 seconds to 300 minutes, more preferably 1 minute to 200 minutes, and still more preferably 3 minutes to 180 minutes.

In the case of immersing the cut wire in the cleaning liquid, a mass ratio between the cut wire and the cleaning liquid can be appropriately adjusted according to the type, the concentration, and the temperature of the cleaning liquid to be used. A ratio of the mass of the cut wire to be immersed to the mass of the cleaning liquid is usually in a range of 1 to 70% by mass, and preferably 10 to 50% by mass. It is desirable from the viewpoint of economy that the ratio is in the above range since it is easy to suppress readhesion of impurities eluted in the cleaning liquid to the cut wire and also appropriate volume efficiency is achieved.

Cleaning may be performed once or plural times using one cleaning liquid, or may be performed plural times using two or more cleaning liquids in combination.

When the cleaning liquid contains an acid or an alkali, a surface of the cut wire is partially eluted and removed by bringing it into contact with the cleaning liquid. In the cleaning step, a mass reduction rate of the cut wire after contacting with the cleaning liquid is preferably 0.01% or more, more preferably 0.1% or more, still more preferably 1% or more, preferably 20% or less, more preferably 10% or less, and still more preferably 2% or less, based on the mass of the cut wire before contacting with the cleaning liquid in the cleaning step. It is desirable that the mass reduction rate is the lower limit value or more since the resulting aluminium grain material has higher purity. It is desirable that the mass reduction rate is the upper limit value or less since satisfactory productivity is achieved.

The method for producing an aluminium grain material of the present invention may include the step of vacuum packaging of the aluminium grain material obtained after cleaning in a resin bag not containing a lubricant, an antioxidant, and an antiblocking agent. This step enables suppression of adhesion of impurities from the periphery, and a chemical reaction such as oxidation of a surface of the aluminium grain material.

The above method enables production of the aluminium grain material of the present invention. The aluminium grain material of the present invention has significantly high purity and preferably exhibits less variation in shape, so that it can be preferably used as a material for forming a film of aluminium, or a material for forming a film of aluminium-containing inorganic compound(s).

### EXAMPLE

The present invention will be described in detail below by way of Examples, but the present invention is not limited thereto.

### Production Example 1

Primary aluminium having a purity of 99.92% by mass was purified in the same manner as in JP 5274981 B1 to obtain a high-purity aluminium ingot having a purity of 99.9999% by mass. The high-purity aluminium ingot thus obtained was partially cut out and impurities contained therein were measured by glow discharge mass spectrometry (GDMS). As a result, the total value of twelve elements as impurities was 0.65 ppm by mass. Next, the high-purity aluminium ingot thus obtained was formed into a cylindrical shape by machining such as sawing to obtain an extrusion material. This extrusion material was inserted into an extrusion container and then extruded toward a mold (die) under pressure to obtain an aluminium wire material (having a wire diameter of 6.4 mm) without performing special cleaning. The aluminium wire material thus obtained was subjected to recasting and impurities contained in the aluminium wire material were measured by glow discharge mass spectrometry (GDMS). As a result, the total content of the above-mentioned twelve elements was 1.0 ppm by mass.

### Example 1

In the cutting step, the aluminium wire material obtained in Production Example 1 was disposed in the material feed section of an automatic cutting machine, and then automatic cutting was performed at an automatic feed of about 3 mm to obtain a cut wire.

The cut wire thus obtained was cleaned using kerosene and burr of the cut wire formed during cutting was removed by repeating rotation and dropping using a barrel device (barrel processing), and the kerosene cleaning was performed again.

Thereafter, in the cleaning step, the cut wire thus obtained was immersed in aqua regia obtained by mixing at a volume ratio (35% hydrochloric acid/60% nitric acid=3/1) at room temperature (20° C.) in accordance with the cleaning method shown in Table 1 for 3 minutes immersion to obtain an aluminium grain material (1) having an average mass per grain of 0.23 g, a wire diameter of 6.4 mm, and a length of 3 mm.

### Example 2

In the same manner as in Example 1, except that the cut wire was immersed in aqua regia at room temperature (20° C.) for 15 minutes in the cleaning step, an aluminium grain material (2) having an average mass per grain of 0.21 g, a wire diameter of 6.2 mm, and a length of 3 mm was obtained.

### Example 3

In the same manner as in Example 1, except that a cut wire was first immersed in an aqueous surfactant-containing phosphate solution (in pure water, 5% by mass, neutral) which is a circulation cleaning agent at room temperature (20° C.) for 10 minutes in the cleaning step, and then immersed in aqua regia under stirring at room temperature (20° C.) for 10 minutes in the secondary cleaning step, an aluminium grain material (3) having an average mass per grain of 0.22 g, a wire diameter of 6.3 mm, and a length of 3 mm was obtained.

### Example 4

In the same manner as in Example 1, except that the total content of twelve elements in the extrusion material was 1.7 ppm by mass (aluminium purity was 99.9998% by mass), cutting was performed so that the length of the cut wire becomes 19 mm, and the cleaning method in the cleaning step was a method in which cleaning was performed in an aqueous 17% by mass hydrochloric acid solution for 180 minutes, an aluminium grain material (4) having an average mass per grain of 1.6 g, a wire diameter of 6.4 mm, and a length of 19 mm was obtained.

### Example 5

In the same manner as in Example 1, except that the total content of twelve elements in the extrusion material was 1.7 ppm by mass (aluminium purity was 99.9998% by mass), cutting was performed so that the length of the cut wire becomes 19 mm, and the cleaning method in the cleaning step was a method in which cleaning was performed in an aqueous 10% by mass sodium hydroxide solution for 5 minutes, an aluminium grain material (5) having an average mass per grain of 1.6 g, a wire diameter of 6.4 mm, and a length of 19 mm was obtained.

### Example 6

In the same manner as in Example 1, except that the cut wire was immersed in an aqueous surfactant-containing phosphate solution (in pure water, 5% by mass, neutral) which is a circulation cleaning agent at room temperature (20° C.) for 10 minutes immersion in the cleaning step, an aluminium grain material (6) having an average mass per grain of 0.23 g, a wire diameter of 6.4 mm, and a length of 3 mm was obtained.

### Example 7

In the same manner as in Example 6, except that the cut wire was immersed in an aqueous surfactant-containing phosphate solution in the cleaning step, and then immersed in pure water prepared by Milli-Q System manufactured by Nihon Millipore K.K. for 15 minutes while performing an ultrasonic treatment using an ultrasonic cleaner (manufactured by KAIJO corporation, AUTOPARSER 200) in the secondary cleaning step, an aluminium grain material (7) having an average mass per grain of 0.23 g, a wire diameter of 6.4 mm, and a length of 3 mm was obtained.

### Example 8

In the same manner as in Example 6, except that the cut wire was immersed in an aqueous surfactant-containing phosphate solution in the cleaning step, and then immersed in ethanol for 15 minutes while performing an ultrasonic treatment using an ultrasonic cleaner in the secondary cleaning step, an aluminium grain material (8) having an average mass per grain of 0.23 g, a wire diameter of 6.4 mm, and a length of 3 mm was obtained.

### Example 9

In the same manner as in Example 6, except that the cut wire was immersed in an aqueous phosphate solution, and then immersed in methylene chloride for 5 minutes in the secondary cleaning step, an aluminium grain material (9) having an average mass per grain of 0.23 g, a wire diameter of 6.4 mm, and a length of 3 mm was obtained.

### Example 10

In the same manner as in Example 1, except that the total content of twelve elements in the extrusion material was 1.7 ppm by mass (aluminium purity is 99.9998% by mass), cutting was performed so that the length of the cut wire becomes 19 mm, and the cut wire was immersed in ethanol for 20 minutes while performing an ultrasonic treatment in the cleaning step, an aluminium grain material (10) having an average mass per grain of 1.6 g, a wire diameter of 6.4 mm, and a length of 19 mm was obtained.

### Comparative Example 1

In the same manner as in Example 1, except that the total content of twelve elements in the extrusion material was 1.7 ppm by mass (aluminium purity is 99.9998% by mass), cutting was performed so that the length of the cut wire becomes 19 mm, and no cleaning was performed after cutting, an aluminium grain material (11) having an average mass per grain of 1.6 g, a wire diameter of 6.4 mm, and a length of 19 mm was obtained.

TABLE 1

| | | Primary cleaning | | | Secondary cleaning | | |
|---|---|---|---|---|---|---|---|
| | | | Treatment | Immersion | | Treatment | Immersion |
| | | | during | time | Cleaning | during | time |
| | | Cleaning liquid | cleaning | (minutes) | liquid | cleaning | (minutes) |
| Examples | 1 | Aqua regia | — | 3 | — | — | — |
| | 2 | Aqua regia | — | 15 | — | — | — |
| | 3 | Aqueous 5% by | — | 10 | Aqua regia | — | 10 |
| | | mass phosphate | | | | | |
| | | solution | | | | | |
| | 4 | Aqueous 17% by | — | 180 | — | — | — |
| | | mass hydrochoric | | | | | |
| | | acid solution | | | | | |
| | 5 | Aqueous 10% by | — | 5 | — | — | — |
| | | mass sodium | | | | | |
| | | hydroxide | | | | | |
| | | solution | | | | | |
| | 6 | Aqueous 5% by | — | 10 | — | — | — |
| | | mass phosphate | | | | | |
| | | solution | | | | | |
| | 7 | Aqueous 5% by | — | 10 | Pure water | Ultrasonic | 15 |
| | | mass phosphate | | | | treatment | |
| | | solution | | | | | |
| | 8 | Aqueous 5% by | — | 10 | Ethanol | Ultrasonic | 15 |
| | | mass phosphate | | | | treatment | |
| | | solution | | | | | |
| | 9 | Aqueous 5% by | — | 10 | Methylene | — | 5 |
| | | mass phosphate | | | chloride | | |
| | | solution | | | | | |
| | 10 | Ethanol | Ultrasonic | 20 | — | — | — |
| | | | treatment | | | | |
| Comparative | 1 | No cleaning | — | — | — | — | — |
| Examples | | | | | | | |

Each of the aluminium grain materials (1) to (11) obtained in Examples 1 to 10 and Comparative Example 1 was subjected to recasting, and then the total content of twelve elements of Si, Fe, Cu, Mg, Ti, V, Cr, Mn, Ni, Zn, Ga, and Zr contained in the aluminium grain material thus recasted was measured by glow discharge mass spectrometry. The results are shown in Table 2.

Using each of the aluminium grain materials (1) to (11) obtained in Examples 1 to 10 and Comparative Example 1, a mass reduction rate of the cut wire obtained after contacting with the cleaning liquid in the cleaning step was calculated based on the mass of the cut wire before contacting with the cleaning liquid, in accordance with the following equation. The results are shown in Table 2.

Mass reduction rate (%)=[{(mass of cut wire before contacting with cleaning liquid)−(mass of cut wire after contacting with cleaning liquid)}/(mass of cut wire before contacting with cleaning liquid)]×100

TABLE 2

| | | Total content of twelve elements | Mass reduction rate |
|---|---|---|---|
| | | (ppm by mass) | (%) |
| Examples | 1 | 0.70 | 1.7 |
| | 2 | 0.67 | 9.5 |
| | 3 | 0.84 | 3.2 |
| | 4 | 1.2 | 0.23 |
| | 5 | 1.2 | 0.15 |
| | 6 | 2.2 | 0.0 |
| | 7 | 1.6 | 0.0 |
| | 8 | 2.1 | 0.0 |
| | 9 | 2.3 | 0.0 |
| | 10 | 2.7 | 0.0 |
| Comparative | 1 | 1.6 | — |
| Examples | | | |

It is apparent that the aluminium grain materials (1) to (10) obtained in Examples 1 to 10 exhibited the low total content of twelve elements and aluminium grain materials having significantly high purity were obtained. Meanwhile, the aluminium grain material (11) obtained in Comparative Example 1 which was not subjected to the cleaning step exhibited significantly high total content of twelve elements.

With respect to the aluminium grain material (1) obtained in Example 1, variation in mass, variation in wire diameter, and variation in length were evaluated. The evaluation was performed by the following procedure. Twenty samples were selected at random from aluminium grain materials. The mass was measured by an electronic balance, and the wire diameter and the length were measured using a digital thickness gauge. Variation in mass, variation in wire diameter, and variation in length were evaluated from the measured values by the above-mentioned methods. As a result, variation in mass was 0.62%, variation in wire diameter was 0.70%, and variation in length was 0.50%. Twenty samples were selected at random from commercially available high-purity aluminium shot materials (having an aluminium purity of 99.99% by mass, a mass of 0.6 to 0.7 g, and a diameter of 5 to 10 mm), and then the mass, the diameter, and the height were measured and evaluated. The height of the shot material was obtained by measuring a distance between two almost flat surfaces of the shot material using a digital thickness gauge. The diameter of the shot material was obtained by measuring at an intermediate position in the height direction of the shot material (position where the height from the bottom face becomes ½ of the height of the shot material) using a digital thickness gauge. As a result of evaluation six times, variation in mass was in a range of 6.5% to 16%. As a result of evaluation twice, variation in diameter was in a range of 6.0% to 8.9%. As a result of evaluation six times, variation in height was in a range of 6.8% to 14.4%. These results reveal that the aluminium grain material of the present invention exhibit less variation in mass and shape as compared with the shot material.

When hydrochloric acid is used as the cleaning liquid, like Example 4, although a chlorine element is contained in the cleaning liquid, the content of the chlorine element of a surface of aluminium exhibited 20% or less of the content before cleaning. When cleaning was performed using the aqueous sodium hydroxide solution, like Example 5, although a sodium element is contained in the cleaning liquid, the content of the sodium element of a surface of aluminium exhibited 10% or less of the content before cleaning.

These results reveal that it is advantageous to use these aluminium grain materials of the present invention for formation of a thin film that needs avoidance of mixing of heteroelements such as chlorine and sodium elements, including sulfur, iron, and silicon elements.

1. An aluminium grain material having an average mass per grain of 0.01 to 10 g, wherein
the total content of twelve elements of silicon (Si), iron (Fe), copper (Cu), magnesium (Mg), titanium (Ti), vanadium (V), chromium (Cr), manganese (Mn), nickel (Ni), zinc (Zn), gallium (Ga), and zirconium (Zr) in the aluminium grain material, measured by glow discharge mass spectrometry, is 5 ppm by mass or less.

2. The aluminium grain material according to claim 1, wherein the total content of the twelve elements is 2.5 ppm by mass or less.

3. The aluminium grain material according to claim 1, wherein variation in mass indicated by a value obtained by dividing a standard deviation of the mass of the aluminium grain material by an average of the mass, is 5% or less, in the twenty aluminium grain materials.

4. The aluminium grain material according to claim 2, wherein variation in mass indicated by a value obtained by dividing a standard deviation of the mass of the aluminium grain material by an average of the mass, is 5% or less, in the twenty aluminium grain materials.

5. The aluminium grain material according to claim 1, wherein the aluminium grain material is a cut wire.

6. The aluminium grain material according to claim 4, wherein the aluminium grain material is a cut wire.

7. The aluminium grain material according to claim 5, wherein the cut wire has a wire diameter of 0.3 to 20 mm and a length of 1 to 50 mm.

8. The aluminium grain material according to claim 6, wherein the cut wire has a wire diameter of 0.3 to 20 mm and a length of 1 to 50 mm.

9. The aluminium grain material according to claim 5, wherein variation in wire diameter indicated by a value obtained by dividing a standard deviation of the wire diameter of the cut wire by an average of the wire diameter, is 5% or less, and variation in length indicated by a value obtained by dividing a standard deviation of the length of the cut wire by an average of the length, is 5% or less, in the twenty cut wires.

10. The aluminium grain material according to claim 6, wherein variation in wire diameter indicated by a value obtained by dividing a standard deviation of the wire diameter of the cut wire by an average of the wire diameter, is 5% or less, and variation in length indicated by a value obtained by dividing a standard deviation of the length of the cut wire by an average of the length, is 5% or less, in the twenty cut wires.

11. The aluminium grain material according to claim 7, wherein variation in wire diameter indicated by a value obtained by dividing a standard deviation of the wire diameter of the cut wire by an average of the wire diameter, is 5% or less, and variation in length indicated by a value obtained by dividing a standard deviation of the length of the cut wire by an average of the length, is 5% or less, in the twenty cut wires.

12. The aluminium grain material according to claim 8, wherein variation in wire diameter indicated by a value obtained by dividing a standard deviation of the wire diameter of the cut wire by an average of the wire diameter, is 5% or less, and variation in length indicated by a value obtained by dividing a standard deviation of the length of the cut wire by an average of the length, is 5% or less, in the twenty cut wires.

13. The aluminium grain material according to claim 1 for forming a film of aluminium, or a film of aluminium-containing inorganic compound(s).

14. The aluminium grain material according to claim 1 vacuum-packaged in a resin bag not containing a lubricant, an antioxidant, and an antiblocking agent.

15. A method for producing the aluminium grain material according to claim 1, which comprises:
a cutting step of cutting an aluminium wire material to obtain a cut wire, and
a cleaning step of bringing the cut wire into contact with a cleaning liquid to obtain the aluminium grain material.

16. The method according to claim 15, wherein the cleaning liquid is a solution containing at least one selected from the group consisting of hydrochloric acid, nitric acid, sulfuric acid, oxalic acid, citric acid, sodium carbonate, tartaric acid, sodium hydroxide, phosphate, sodium gluconate, and sodium metasilicate.

17. The method according to claim 15, wherein a mass reduction rate of the cut wire after contacting with the cleaning liquid is in a range of 0.01 to 20% based on the mass of the cut wire before contacting with the cleaning liquid in the cleaning step.

18. The method according to claim 16, wherein a mass reduction rate of the cut wire after contacting with the cleaning liquid is in a range of 0.01 to 20% based on the mass of the cut wire before contacting with the cleaning liquid in the cleaning step.

19. The method according to claim 15, wherein a mass reduction rate of the cut wire after contacting with the cleaning liquid is in a range of 0.1 to 10% based on the mass of the cut wire before contacting with the cleaning liquid in the cleaning step.

20. The method according to claim 16, wherein a mass reduction rate of the cut wire after contacting with the cleaning liquid is in a range of 0.1 to 10% based on the mass of the cut wire before contacting with the cleaning liquid in the cleaning step.
